(19) United States
(12) Patent Application Publication
(10) Pub. No.: US 2022/0284748 A1
(43) Pub. Date: Sep. 8, 2022

(54) Automated Loading Dock Detection and Management System, Method, and Apparatus

(71) Applicant: Inteligistics, Inc., Pittsburgh, PA (US)

(72) Inventors: Eric John Muriungi Kithinji, Salinas, CA (US); Panduranga Rao Mandava, Pittsburgh, PA (US); Prasanna Jayaramaiah Gowda, Pittsburgh, PA (US); Lawrence Mallia, Carmel, CA (US)

(21) Appl. No.: 17/685,451

(22) Filed: Mar. 3, 2022

Related U.S. Application Data
(60) Provisional application No. 63/157,016, filed on Mar. 5, 2021.

(51) Int. Cl. G07C 9/00; G07C 5/00; G06T 11/00; G06F 3/0484; H04W 4/44; H04W 4/021

(52) U.S. Cl. CPC G07C 9/00309; G07C 5/008; G06T 11/001; G06F 3/0484; H04W 4/44; H04W 4/021; G06T 2200/24

(57) ABSTRACT

Provided is an automated loading dock detection and management system, method, and apparatus. The system includes a plurality of vehicle sensors arranged with respect to a plurality of loading docks, a plurality of door sensors arranged with respect to a plurality of doors associated with the plurality of loading docks, and at least one processor in communication with the plurality of vehicle sensors and the plurality of door sensors, the at least one processor configured to receive a plurality of signals from at least a subset of vehicle sensors of the plurality of vehicle sensors and at least a subset of door sensors from the plurality of door sensors, start and/or stop at least one timer based on the plurality of signals, and generate a graphical interface based on the at least one timer.

### CROSS REFERENCE TO RELATED APPLICATION

This application claims priority to U.S. Provisional Patent Application No. 63/157,016, filed Mar. 5, 2021, the disclosure of which is incorporated herein by reference in its entirety.

### BACKGROUND

### 1. Field

This disclosure relates generally to loading docks, and in non-limiting embodiments, to systems, methods, and computer-program products for loading dock detection and management.

### 2. Technical Considerations

Existing vehicle detection systems utilize mechanical switches that are triggered by a truck backing into them and actuating the switch. Such switches wear out over time and are not reliable. Moreover, loading docks with multiple doors are typically managed by human operators who open and close the door as trucks arrive and leave the docks. Trucks often wait for long periods of time at a loading dock before being loaded or unloaded, affecting the efficiency of the driver and the loading dock. This also can have a detrimental effect on perishable goods like produce, which may need to be moved into a cooling facility. Other reasons for delay in loading trucks is that the product is not readily available in staging areas, personnel are not available to bring product to dock or to load, operator inefficiency and various other reasons like mechanical failures of dock door infrastructure and lack of maintenance etc.

### SUMMARY

According to non-limiting embodiments or aspects, provided is a system comprising: a plurality of vehicle sensors arranged with respect to a plurality of loading docks, wherein each loading dock is associated with at least one vehicle sensor; a plurality of door sensors arranged with respect to a plurality of doors associated with the plurality of loading docks, wherein each loading dock is associated with at least one door and at least one door sensor; and at least one processor in communication with the plurality of vehicle sensors and the plurality of door sensors, the at least one processor configured to: receive a plurality of signals from at least a subset of vehicle sensors of the plurality of vehicle sensors and at least a subset of door sensors from the plurality of door sensors; start and/or stop at least one timer based on the plurality of signals; and generate a graphical interface based on the at least one timer.

In non-limiting embodiments or aspects, the graphical user interface comprises a plurality of sections, each section of the plurality of sections associated with a different loading dock of the plurality of loading docks. In non-limiting embodiments or aspects, at least one section of the plurality of sections comprises a timer display visually representing the at least one timer. In non-limiting embodiments or aspects, the at least one processor is further configured to: determine when the at least one timer satisfies a first threshold; and in response to determining that the at least one timer satisfies the first threshold, modify the timer display by changing a color or other identifiable feature of the timer display. In non-limiting embodiments or aspects, the at least one timer represents at least one of the following: a time from which a vehicle is detected by a vehicle sensor at a corresponding loading dock, a time from which a door at a corresponding loading dock is opened, a time from which a door at a corresponding loading dock is closed and a vehicle is still detected by a vehicle sensor at the corresponding loading dock.

In non-limiting embodiments or aspects, the system includes a sensor gateway in communication with the plurality of vehicle sensors and/or the plurality of door sensors, the sensor gateway configured to communicate sensor data to the at least one processor. In non-limiting embodiments or aspects, the plurality of vehicle sensors and/or the plurality of door sensors are connected to the sensor gateway wirelessly. In non-limiting embodiments or aspects, each vehicle sensor of the plurality of vehicle sensors comprises an ultrasonic sensor arranged at a height above a ground surface such that the vehicle sensor detects a top portion of a truck below the vehicle sensor.

In non-limiting embodiments or aspects, the system includes a mobile application executing on a mobile device operated by a driver, the mobile application including program instructions that, when executed by the mobile device, cause the mobile device to: receive, from the at least one processor, data generated from the plurality of signals; and in response to receiving the data, display a graphical user interface configured to enable the driver to check-in or check-out. In non-limiting embodiments or aspects, the program instructions further cause the mobile device to: automatically detect that the mobile device is in a geographic area; and in response to detecting that the mobile device is in a geographic area, communicating a notification to the at least one processor. In non-limiting embodiments or aspects, the program instructions further cause the mobile device to display a mobile graphical interface based on the graphical interface.

According to non-limiting embodiments or aspects, provided is a computer program product comprising at least one non-transitory computer readable medium including program instructions that, when executed by at least one processor, cause the at least one processor to: receive a plurality of signals from at least a subset of vehicle sensors of a plurality of vehicle sensors and at least a subset of door sensors from a plurality of door sensors, the plurality of vehicle sensors is arranged with respect to a plurality of loading docks, and the plurality of door sensors is arranged with respect to a plurality of doors associated with the plurality of loading docks, each loading dock associated with at least one door, at least one vehicle sensor, and at least one door sensor; start and/or stop at least one timer based on the plurality of signals; and generate a graphical interface based on the at least one timer.

In non-limiting embodiments or aspects, the graphical interface comprises a plurality of sections, each section of the plurality of sections associated with a different loading dock of the plurality of loading docks. In non-limiting embodiments or aspects, wherein at least one section of the plurality of sections comprises a timer display visually representing the at least one timer. In non-limiting embodiments or aspects, the at least one processor is further caused to: determine when the at least one timer satisfies a first threshold; in response to determining that the at least one timer satisfies the first threshold, modify the timer display by changing a color of the timer display. In non-limiting embodiments or aspects, the at least one timer represents at least one of the following: a time from which a vehicle is detected by a vehicle sensor at a corresponding loading dock, a time from which a door at a corresponding loading dock is opened, a time from which a door at a corresponding loading dock is closed and a vehicle is still detected by a vehicle sensor at the corresponding loading dock.

In non-limiting embodiments or aspects, the at least one processor receives the plurality of signals from a sensor gateway in communication with the plurality of vehicle sensors and/or the plurality of door sensors. In non-limiting embodiments or aspects, the plurality of vehicle sensors and/or the plurality of door sensors are connected to the sensor gateway wirelessly. In non-limiting embodiments or aspects, each vehicle sensor of the plurality of vehicle sensors comprises an ultrasonic sensor or any other suitable sensor arranged at a height above a ground surface such that the vehicle sensor detects a top portion of a truck below the vehicle sensor. In non-limiting embodiments or aspects, the program instructions further cause the mobile device to display a mobile graphical interface based on the graphical interface.

According to non-limiting embodiments or aspects, provided is a method comprising: arranging a plurality of vehicle sensors with respect to a plurality of loading docks, wherein each loading dock is associated with at least one vehicle sensor; arranging a plurality of door sensors with respect to a plurality of doors associated with the plurality of loading docks, wherein each loading dock is associated with at least one door and at least one door sensor; receiving a plurality of signals from at least a subset of vehicle sensors of the plurality of vehicle sensors and at least a subset of door sensors from the plurality of door sensors; starting and/or stopping at least one timer based on the plurality of signals; and generating a graphical interface based on the at least one timer.

In non-limiting embodiments or aspects, the graphical user interface comprises a plurality of sections, each section of the plurality of sections associated with a different loading dock of the plurality of loading docks. In non-limiting embodiments or aspects, at least one section of the plurality of sections comprises a timer display visually representing the at least one timer. In non-limiting embodiments or aspects, the method includes determining when the at least one timer satisfies a first threshold; and in response to determining that the at least one timer satisfies the first threshold, modifying the timer display by changing a color of the timer display. In non-limiting embodiments or aspects, the at least one timer represents at least one of the following: a time from which a vehicle is detected by a vehicle sensor at a corresponding loading dock, a time from which a door at a corresponding loading dock is opened, a time from which a door at a corresponding loading dock is closed and a vehicle is still detected by a vehicle sensor at the corresponding loading dock.

In non-limiting embodiments or aspects, the method includes communicating sensor data to a processor via a sensor gateway. In non-limiting embodiments or aspects, the plurality of vehicle sensors and/or the plurality of door sensors are connected to the sensor gateway wirelessly. In non-limiting embodiments or aspects, each vehicle sensor of the plurality of vehicle sensors comprises an ultrasonic sensor arranged at a height above a ground surface such that the vehicle sensor detects a top portion of a truck below the vehicle sensor. In non-limiting embodiments or aspects, the method includes receiving, with a mobile application executing on a mobile device operated by a driver, data generated from the plurality of signals; and in response to receiving the data, displaying, on the mobile device, a graphical user interface configured to enable the driver to check-in or check-out. In non-limiting embodiments or aspects, the method includes automatically detecting that the mobile device is in a geographic area; and in response to detecting that the mobile device is in a geographic area, communicating, from the mobile device, a notification to the at least one processor.

Further non-limiting embodiments or aspects are set forth in the following numbered clauses:

Clause 1: A system comprising: a plurality of vehicle sensors arranged with respect to a plurality of loading docks, wherein each loading dock is associated with at least one vehicle sensor; a plurality of door sensors arranged with respect to a plurality of doors associated with the plurality of loading docks, wherein each loading dock is associated with at least one door and at least one door sensor; and at least one processor in communication with the plurality of vehicle sensors and the plurality of door sensors, the at least one processor configured to: receive a plurality of signals from at least a subset of vehicle sensors of the plurality of vehicle sensors and at least a subset of door sensors from the plurality of door sensors; start and/or stop at least one timer based on the plurality of signals; and generate a graphical interface based on the at least one timer.

Clause 2: The system of clause 1, wherein the graphical user interface comprises a plurality of sections, each section of the plurality of sections associated with a different loading dock of the plurality of loading docks.

Clause 3: The system of clauses 1 or 2, wherein at least one section of the plurality of sections comprises a timer display visually representing the at least one timer.

Clause 4: The system of any of clauses 1-3, wherein the at least one processor is further configured to: determine when the at least one timer satisfies a first threshold; and in response to determining that the at least one timer satisfies the first threshold, modify the timer display by changing a color or other identifiable feature of the timer display.

Clause 5: The system of any of clauses 1-4, wherein the at least one timer represents at least one of the following: a time from which a vehicle is detected by a vehicle sensor at a corresponding loading dock, a time from which a door at a corresponding loading dock is opened, a time from which a door at a corresponding loading dock is closed and a vehicle is still detected by a vehicle sensor at the corresponding loading dock.

Clause 6: The system of any of clauses 1-5, further comprising a sensor gateway in communication with the plurality of vehicle sensors and/or the plurality of door sensors, the sensor gateway configured to communicate sensor data to the at least one processor.

Clause 7: The system of any of clauses 1-6, wherein the plurality of vehicle sensors and/or the plurality of door sensors are connected to the sensor gateway wirelessly.

Clause 8: The system of any of clauses 1-7, wherein each vehicle sensor of the plurality of vehicle sensors comprises an ultrasonic sensor arranged at a height above a ground surface such that the vehicle sensor detects a top portion of a truck below the vehicle sensor.

Clause 9: A computer program product comprising at least one non-transitory computer readable medium including program instructions that, when executed by at least one processor, cause the at least one processor to: receive a plurality of signals from at least a subset of vehicle sensors of a plurality of vehicle sensors and at least a subset of door sensors from a plurality of door sensors, wherein the plurality of vehicle sensors is arranged with respect to a plurality of loading docks, and wherein the plurality of door sensors is arranged with respect to a plurality of doors associated with the plurality of loading docks, each loading dock associated with at least one door, at least one vehicle sensor, and at least one door sensor; start and/or stop at least one timer based on the plurality of signals; and generate a graphical interface based on the at least one timer.

Clause 10: The computer program product of clause 9, wherein the graphical interface comprises a plurality of sections, each section of the plurality of sections associated with a different loading dock of the plurality of loading docks.

Clause 11: The computer program product of clauses 9 or 10, wherein at least one section of the plurality of sections comprises a timer display visually representing the at least one timer.

Clause 12: The computer program product of any of clauses 9-11, wherein the at least one processor is further caused to: determine when the at least one timer satisfies a first threshold; in response to determining that the at least one timer satisfies the first threshold, modify the timer display by changing a color of the timer display.

Clause 13: The computer program product of any of clauses 9-12, wherein the at least one timer represents at least one of the following: a time from which a vehicle is detected by a vehicle sensor at a corresponding loading dock, a time from which a door at a corresponding loading dock is opened, a time from which a door at a corresponding loading dock is closed and a vehicle is still detected by a vehicle sensor at the corresponding loading dock.

Clause 14: The computer program product of any of clauses 9-13, wherein the at least one processor receives the plurality of signals from a sensor gateway in communication with the plurality of vehicle sensors and/or the plurality of door sensors.

Clause 15: The computer program product of any of clauses 9-14, wherein the plurality of vehicle sensors and/or the plurality of door sensors are connected to the sensor gateway wirelessly.

Clause 16: The computer program product of any of clauses 9-15, wherein each vehicle sensor of the plurality of vehicle sensors comprises an ultrasonic sensor arranged at a height above a ground surface such that the vehicle sensor detects a top portion of a truck below the vehicle sensor.

Clause 17: A method comprising: arranging a plurality of vehicle sensors with respect to a plurality of loading docks, wherein each loading dock is associated with at least one vehicle sensor; arranging a plurality of door sensors with respect to a plurality of doors associated with the plurality of loading docks, wherein each loading dock is associated with at least one door and at least one door sensor; receiving a plurality of signals from at least a subset of vehicle sensors of the plurality of vehicle sensors and at least a subset of door sensors from the plurality of door sensors; starting and/or stopping at least one timer based on the plurality of signals; and generating a graphical interface based on the at least one timer.

Clause 18: The method of clause 17, wherein the graphical user interface comprises a plurality of sections, each section of the plurality of sections associated with a different loading dock of the plurality of loading docks.

Clause 19: The method of clauses 17 or 18, wherein at least one section of the plurality of sections comprises a timer display visually representing the at least one timer.

Clause 20: The method of any of clauses 17-19, further comprising determining when the at least one timer satisfies a first threshold; and in response to determining that the at least one timer satisfies the first threshold, modifying the timer display by changing a color of the timer display.

Clause 21: The method of any of clauses 17-20, wherein the at least one timer represents at least one of the following: a time from which a vehicle is detected by a vehicle sensor at a corresponding loading dock, a time from which a door at a corresponding loading dock is opened, a time from which a door at a corresponding loading dock is closed and a vehicle is still detected by a vehicle sensor at the corresponding loading dock.

Clause 22: The method of any of clauses 17-21, further comprising communicating sensor data to a processor via a sensor gateway.

Clause 23: The method of any of clauses 17-22, wherein the plurality of vehicle sensors and/or the plurality of door sensors are connected to the sensor gateway wirelessly.

Clause 24: The method of any of clauses 17-23, wherein each vehicle sensor of the plurality of vehicle sensors comprises an ultrasonic sensor arranged at a height above a ground surface such that the vehicle sensor detects a top portion of a truck below the vehicle sensor.

Clause 25: The system of any of clauses 1-8, further comprising a mobile application executing on a mobile device operated by a driver, the mobile application including program instructions that, when executed by the mobile device, cause the mobile device to: receive, from the at least one processor, data generated from the plurality of signals; and in response to receiving the data, display a graphical user interface configured to enable the driver to check-in or check-out.

Clause 26: The system of any of clauses 1-8 and 25, wherein the program instructions further cause the mobile device to: automatically detect that the mobile device is in a geographic area; and in response to detecting that the mobile device is in a geographic area, communicating a notification to the at least one processor.

Clause 27: The system of any of clauses 1-8, 25, and 26, wherein the program instructions further cause the mobile device to display a mobile graphical interface based on the graphical interface.

Clause 28: The method of any of clauses 17-24, further comprising: receiving, with a mobile application executing on a mobile device operated by a driver, data generated from the plurality of signals; and in response to receiving the data, displaying, on the mobile device, a graphical user interface configured to enable the driver to check-in or check-out.

Clause 29: The method of any of clauses 17-24 and 28, further comprising: automatically detecting that the mobile device is in a geographic area; and in response to detecting that the mobile device is in a geographic area, communicating, from the mobile device, a notification to the at least one processor.

Clause 30: The method of any of clauses 17-24, 28, and 29, wherein the program instructions further cause the mobile device to display a mobile graphical interface based on the graphical interface.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying figures, in which:

FIG. 1 illustrates a system for loading dock detection and management according to non-limiting embodiments or aspects;

FIGS. 2A-2C illustrate graphical interfaces of a system for loading dock detection and management according to non-limiting embodiments or aspects;

FIG. 3 illustrates example components of a computing device used in connection with non-limiting embodiments or aspects;

FIGS. 4A and 4B illustrate mobile device GUIs according to non-limiting embodiments or aspects;

FIG. 5 illustrates a dashboard GUI 500 for displaying reports and analytics according to non-limiting embodiments or aspects; and

FIG. 6 shows a chart GUI 600 for displaying a summary of data from a period of time according to non-limiting embodiments or aspects.

### DETAILED DESCRIPTION

It is to be understood that the embodiments may assume various alternative variations and step sequences, except where expressly specified to the contrary. It is also to be understood that the specific devices and processes described in the following specification are simply exemplary embodiments or aspects of the disclosure. Hence, specific dimensions and other physical characteristics related to the embodiments or aspects disclosed herein are not to be considered as limiting. No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Also, as used herein, the terms “has,” “have,” “having,” or the like are intended to be open-ended terms. Further, the phrase “based on” is intended to mean “based at least partially on” unless explicitly stated otherwise.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. A computing device may also be a desktop computer or other form of non-mobile computer, an edge device, or a gateway between sensors and another computer or cloud computer. In non-limiting embodiments, a computing device may include a Central Processing Unit (CPU), Graphics Processing Unit (GPU), microprocessor, and/or the like. In non-limiting embodiments, a computing device may be comprised of a plurality of circuits.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

The present disclosure describes new systems, methods, and computer program products for automating loading dock detection and management that provides for advantages over existing loading docks. For example, a unique arrangement of sensors for both doors and vehicles allows for graphical user interfaces to be generated based on real-time data and interactions. A dynamic, continually updating graphical user interface may be arranged on one or more monitors in a loading dock environment and may update based on the actions taken in the loading dock environment. Implementations of the systems and methods described herein reduce the computational resources needed to have a separate monitoring system for each loading dock and/or loading dock door by including an arrangement of sensors for multiple loading docks and loading dock doors that can be used to generate one or more combined graphical interfaces. The real-time information made available also permits for efficient use of the loading dock environment and creates a database of historical data that can be used for reports and analytics, allowing for optimal usage of the loading docks, more deliveries, and more product transported.

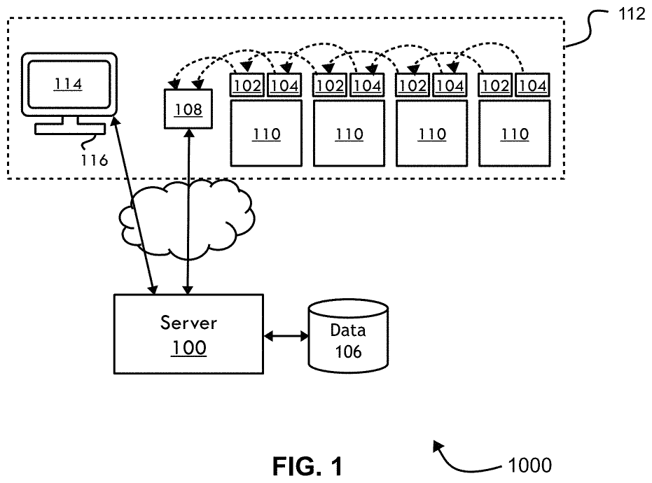

Referring now to FIG. 1, a system 1000 for loading dock detection and management is shown according to non-limiting embodiments. A number of loading docks 110 are shown in an environment 112, such as a warehouse, distribution center, receiving facility, and/or the like. Each loading dock 110 is associated with a door sensor 102 and a vehicle sensor 104. The door sensor 102 may detect the state of a door associated with a loading dock 110, such as whether the door is open or closed. The door sensor 102 may detect the state of the door using infrared, ultrasonic waves, an interface to an existing control system for the door, and/or the like. The vehicle sensor 104 may be arranged such that it detects the presence of a vehicle, such as a truck, at a particular loading dock 110. For example, the vehicle sensor 104 may be arranged outside of the loading dock and above the loading dock door, such that it detects the tops of trucks that are beneath it (e.g., and are therefore at the loading dock 110 door). In non-limiting embodiments, the vehicle sensor 104 is an ultrasonic sensor.

With continued reference to FIG. 1, the sensors 102, 104 may be in communication with a sensor gateway 108. The sensor gateway 108 may receive sensor data from each of the sensors 102, 104 and communicate the sensor data to a server computer 100 over a network environment. The sensor gateway 108 may process the sensor data prior to communicating it to the server computer or, in other examples, may communicate unprocessed (e.g., raw) sensor data. The server computer 100 is shown external to the environment 112 in FIG. 1, although it will be appreciated that the server computer 100 may also be internal to the environment 112 (e.g., a local area network).

FIG. 1 shows the sensors 102, 104 connected to the sensor gateway 108 wirelessly, although it will be appreciated that direct connections and other arrangement are possible. Moreover, power may be provided to each of the sensors via a daisy-chain arrangement, a battery, a direct power connection, and/or the like. FIG. 1 shows a daisy-chain arrangement that begins at the gateway 108 but it will be appreciated that it may be tied to any power source. Further, the sensors 102, 104 may interface directly with the server computer 100 in some examples. It will be appreciated that non-limiting embodiments may include any arrangement to connect the sensors 102, 104 to the server computer 100 with or without a sensor gateway 108.

In non-limiting embodiments, the sensor 102, sensor 104, and/or an additional sensor may include a Time-of-Flight (ToF) sensor. The ToF sensor may be incorporated into a three-dimensional camera, another device, or be used as a standalone sensor. The ToF sensor measures the distance between the sensor and an object (e.g., a truck at the loading dock or a closed door) based on the time difference between the emission of the light and its return to the sensor after being reflected by the object. In non-limiting embodiments, a ToF sensor may be installed such that when the object being monitored (e.g., a door or truck) is not present, the distance measured by the sensor is a large static value. An object may be detected based on a measurement range (e.g., defined by a minimum and maximum value) to create a window of detection. In some examples, more than one window of detection can be used to detect different objects at different distances. In the example detecting a truck, a ToF sensor may point downward such that when the truck is not present at the dock, the measurement returns the distance between the ToF sensor and the ground. When the truck is present at the dock, the ToF sensor may return a range of values based on varying heights of trucks, which fall within a predetermined range.

In non-limiting embodiments, the system 1000 may further include a computing device 116 that displays a dynamic graphical interface 114. The dynamic graphical interface 114 may be displayed, for example, on a monitor (e.g., such as a television, projector, or the like) visible to workers in the environment 112 surrounding the loading docks 110. In some non-limiting embodiments, the computing device 116 may receive sensor data directly from the sensor gateway 108 and/or the sensors 102, 104. In some non-limiting embodiments, the computing device 116 may receive sensor data or display data derived from the sensor data from the server computer 100.

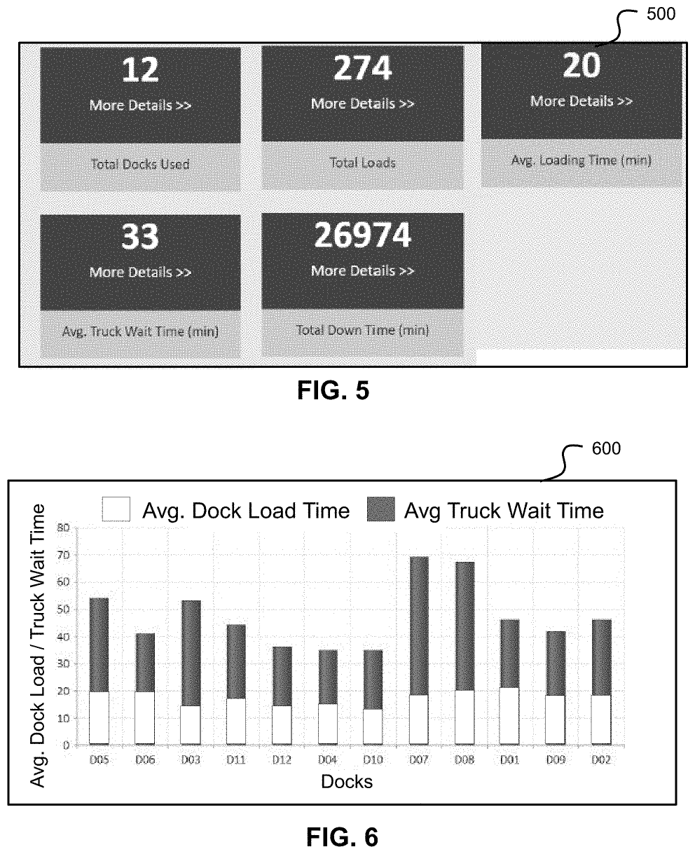

In non-limiting embodiments, the system 1000 may also include one or more data storage devices 106 arranged internal to and/or external to the environment 112. For example, the data storage device 106 may be one or more “cloud-based” (e.g., network-accessible) data storage and processing systems. The data storage device 106 may store data received from the sensors 102, 104 and other data from the system 1000 that may be used to generate reports and/or analytics. Non-limiting examples of such reports and analytics are shown in FIGS. 5 and 6.

In non-limiting embodiments, the graphical interface 114 may be displayed on a monitor proximate to the loading docks. In some non-limiting embodiments, a separate display device (e.g., such as an LED digital clock) may be arranged adjacent to each separate loading dock door. The separate display device may display a timer for that particular door only, such as a timer that begins when the door is opened (e.g., as detected by the door sensor).

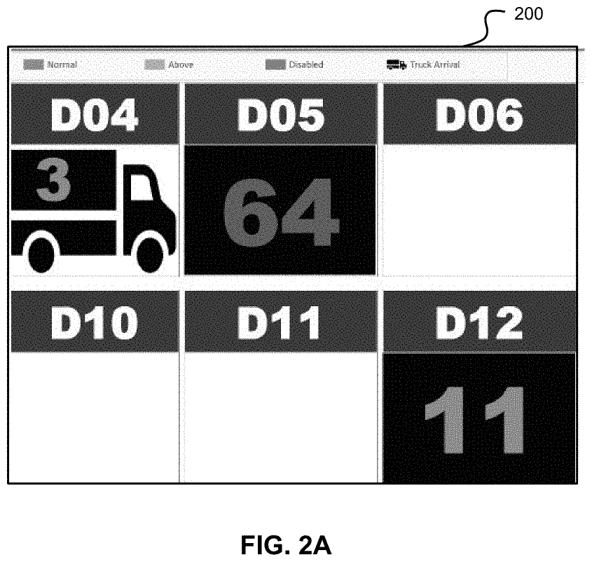

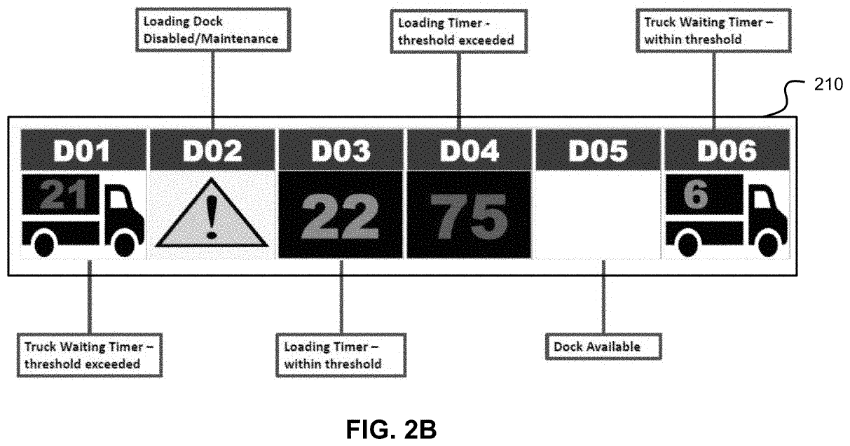

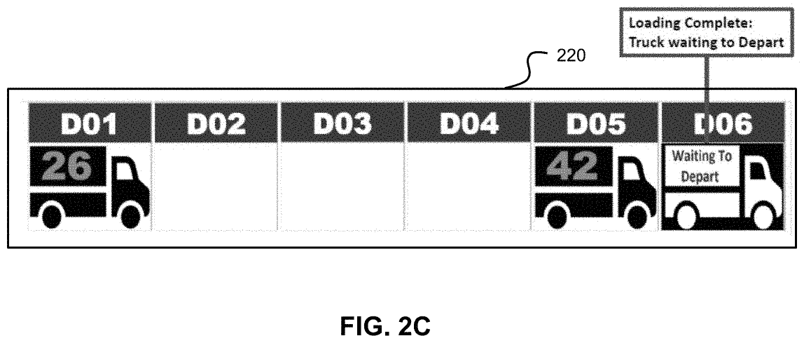

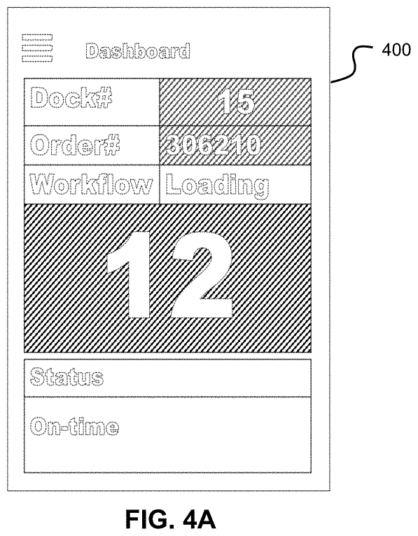

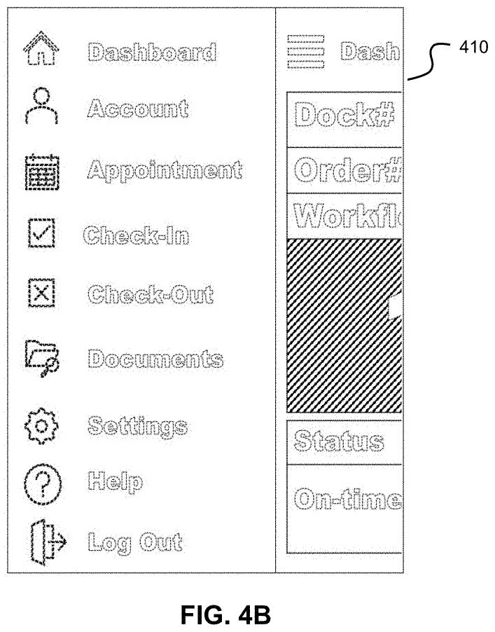

In non-limiting embodiments, users of the system 1000 (e.g., drivers, dock operators, managers, and/or the like) may use one or more software applications on their mobile devices or other computing devices to manually indicate when trucks arrive and leave and when doors open and close. In non-limiting embodiments, the sensors 102, 104 may not be used and user input is used to capture the real-time status of the trucks and/or docks. In non-limiting embodiments, the user input may be used as a back-up in case one or more of the sensors 102, 104 malfunctions. In non-limiting embodiments, one or more mobile GUIs may present selectable options to provide the user input, and such mobile GUIs may include visualizations as shown in FIGS. 2A-2C and FIGS. 4A-4B for viewing the current status of each dock and inputting data. The mobile devices may communicate the information to the server 100 through a network connection. In some examples, the mobile devices may communicate to the server 100 through a gateway. The user inputted data is then stored in one or more data storage devices 106 and used to generate and/or update the dynamic graphical interface 114 and other devices (e.g., a separate display device such as a digital clock).

Referring now to FIGS. 2A-2C, dynamic graphical interfaces 200, 210, 220 are shown according to a non-limiting embodiment. It will be appreciated that the interfaces 200, 210, 220 may be in various arrangements, sizes, and dimensions, and that the examples shown in FIGS. 2A-2C are for example purposes only. The interface 200 shown in FIG. 2A includes a plurality of sections D04, D05, D06, D10, D11, D12, each representing a different loading dock. Any number of loading docks may be displayed on the interface 200. Moreover, in some environments, multiple interfaces 200 may be used such that different loading docks are displayed on different interfaces based on the location of the interface 200.

With continued reference to FIG. 2A, the empty sections D06, D10, D11 indicate that there is no vehicle currently at the corresponding loading dock. The truck icon and timer in section D04 indicates that a vehicle has been detected (e.g., by a vehicle sensor) at the corresponding loading dock for three minutes, but that the door has not been opened yet (e.g., as detected by the door sensor). The timer will continue until the door is detected to be open. The timer may count up or down. When a predetermined threshold has been satisfied (e.g., when the timer is equal to, less than, and/or greater than a threshold), the visual appearance of the icon may change. For example, a color of the timer shown in D04 may change from green to red at a certain threshold. The timer may also include other identifiable features to enable color blind personnel to understand the condition (e.g. hash marks, bold or dotted lines, shape from round to oval, etc.).

Still referring to FIG. 2A, the timer in sections D05 and D12 indicates that a vehicle is at the corresponding loading dock and that the loading dock door has been open for the displayed amount of time (e.g., as detected by the door sensor). The timer will continue until the door is detected as being closed. When a predetermined threshold has been satisfied (e.g., when the timer is equal to, less than, and/or greater than a threshold), the visual appearance of the icon may change. For example, a color of the timer shown in D12 may be green to indicate that a threshold has not been reached at 11 minutes, and a color of the timer shown in D05 may be red to indicate that a threshold has been reached at 64 minutes.

Referring to FIG. 2B, an interface 210 includes a truck icon and timer in section D01 that indicates a vehicle has been detected (e.g., by a vehicle sensor) at the corresponding loading dock for 21 minutes, but that the door has not been opened yet (e.g., as detected by the door sensor). In this example the 21 minute wait may have exceeded a predetermined value and/or a timer may have expired that commenced in response to detection of the truck, which may be indicated with a color code (e.g., red numerals) or other like visual indications. The interface 210 also shows an alert icon in section D02, indicating that an error has occurred and/or that attention is needed. For example, the alert icon may indicate that the loading dock is disabled, undergoing maintenance, and/or the like. In some examples an alert may be displayed automatically in response to detecting an error, such as a door not opening correctly or a sensor error. In some examples an alert may be displayed in response to a user configuring the alert for scheduled maintenance and/or other like reasons.

Referring to FIG. 2C, an interface 220 includes a truck waiting icon in section D06, indicating that a truck has been loaded and is ready to depart, but is still detected at the dock with the vehicle sensor. This may be displayed automatically when the door is closed and the truck remains, as detected with sensors, or in other examples may be initiated manually after a truck is loaded.

In non-limiting embodiments, the system 1000 may be combined with other monitoring and/or scheduling systems, through integration with such systems in various ways. For example, the system 1000 may be integrated with and/or include systems for monitoring crop growing, harvesting, processing, transportation, storage, sale, and/or the like.

In non-limiting embodiments, the system 1000 may be integrated with and/or include systems for predicting one or more parameters related to the loading docks and/or some other aspect of transportation. For example, one or more machine learning models may be implemented to predict when a vehicle or product will arrive at a particular door or for generating recommended action items for increasing the efficiency of the loading docks. Artificial Intelligence and Machine learning may be used to direct truck traffic into and out of the dock, yard management by knowing what customer truck(s) are in which yard location and when a specific customer's truck should be scheduled to arrive at what door for loading, unloading, etc., and also to predict what time the truck will reach its destination using the knowledge of its position for loading/unloading and its travel distance, road conditions, driver's rest, and other regulatory requirements. For example, when the truck is scheduled to cross an international border, appropriate security information and details of the cargo/ownership, etc. can be made available to border agents and alleviate the delays involved in customs inspections and C/TPAT clearances.

In non-limiting embodiments, the system, when interfaced with customer order logs, inventory systems, and cold chain management systems, combined with application of Artificial Intelligence and Machine Learning, can manage a customer order fulfillment system by managing all of the potential gaps that exist in product readiness and availability in the right condition and quantity, appropriately staged at the dock door with personnel available to load when the customer truck pulls in at the dock door.

In some situations, the order scheduling and pickup process is accomplished either via a phone call or email communication in advance of the order pickup (which could be as short as two (2) or three (3) hours, or even days in advance). When the customer (e.g., driver) places an order, they will specify the time of the pickup as well as the details of the order they would be picking up. Upon arrival at the distribution center, they are required to sign-in or check-in at the dispatch/shipping office. This process could typically consist of manual paperwork-based forms that have to be filled out. Upon checking-in, they are instructed to wait at a designated parking area in or outside the yard until their order is ready and a loading dock door is available to back up the truck. For many distribution centers, the dispatch office/staff does not have a view of all the loading docks (e.g., the office might be in a building without a view to the dock area). In this case they may communicate via two-way radios or via telephones to the staff at the dock to check for an available door. Once the dock has been confirmed and an order is staged, the dispatch office will notify the driver to dock the truck at the available door for the loading to begin.

Current restraint and safety systems installed at loading docks use visual indicator LEDs that are manually operated by the loading crew (e.g., changing color such as green or red) to signal to the driver when to enter or depart from the dock area. For example, if the LED status is flashing red, the truck is not allowed to back in. When the LED status is flashing green, the truck is allowed to back in. If the truck is already backed in to the dock and the LED status is red, the driver is not allowed to depart. On the other hand, if the LED status is green, the driver can depart.

Non-limiting embodiments enhance this process by using a mobile device-based user interface and process that operates in conjunction with the real-time door and vehicle detection sensors along with Warehouse Management Systems (WMS) and/or Enterprise Resource Planning (ERP) integrations.

In non-limiting embodiments, the order placement process is streamlined such that the driver performs the operation from the mobile-based user interface. For example, if the system is deployed at customer “Y”, the driver would select customer “Y” as the supplier and input the order details and the appointment date and time. Once the order is submitted, the mobile device (e.g., an application executing on the mobile device) relays the order details to customer “Y”, which is then automatically processed within their WMS/ERP system. In response to the customer processing the order details, a confirmation is sent to the driver acknowledging receipt of the order. This eliminates the need for the driver calling the dispatch office to place an order. The automated process may result in reducing or re-assign staff duties at the dispatch office for staff that would otherwise be dedicated to answering phones to take the orders. Additionally, this streamlines the process for the brokers or drivers placing the order as it would eliminate the hold times on the phones or having to communicate with automated phone systems.

In non-limiting embodiments, the driver check-in process is streamlined upon arrival at the distribution center via the mobile-based user interface. Via the interface (e.g., GUI), the driver can check-in manually. In non-limiting embodiments, a driver may use the mobile-based GUI to schedule a time for arrival and reserve a time slot at a dock based on the estimated time of arrival. The driver may be automatically assigned a dock or the driver may also choose a particular dock.

In other examples, a driver may check-in automatically via the geolocation services provided by the mobile device in conjunction with the application to detect arrival at the scheduled distribution center (e.g., a geofence) and remind the driver to check-in and/or follow a process directed by the interface to fill in required documents or forms. The mobile device may then send a confirmation message to the dispatch office (directly or indirectly relayed). The dispatch office, upon verification of the check-in process, may then send an acknowledgement that is routed, via the application executing on the mobile device, to the driver. Status updates may then be provided in real-time to the driver on the interface. For example, if the driver's order is ready for loading and the dock door is available, the driver would be instructed via the interface to back up the truck at the available dock. This process eliminates the process of requiring the driver to park the truck far away and physically walk to the dispatch office to fill out manual paperwork required for checking in.

In non-limiting embodiments, a truck may be detected at the dock door and a vehicle pre-inspection process may be performed. For loading docks without a view of the outside area (e.g., a transparent window), cameras, or non-functional restraint systems, a driver can back into the dock door and wait inside the truck without anybody inside knowing the truck is present. After a period of time (e.g., 30 minutes) someone may figure out that the truck was already docked waiting for the door to open for loading to start. Automated vehicle detection based on ultrasonic proximity sensors provides a high level of accuracy and reliability that is unaffected by weather conditions that could otherwise be challenging for most of other technologies, such as light-based technologies. Additionally, false detection events such as those triggered by other objects, birds, or people walking around the dock area are not desired. Ultrasonic proximity sensors solve this challenge by using a window detection mode where objects outside the defined detection range (e.g., window) are ignored. When the vehicle is detected, the loading staff is instantly made aware of the status via a dashboard or GUI as indicated in FIG. 2. For example, D04 indicates to the loading staff that it has been three (3) minutes since the truck arrived at the dock. Without having to open the dock door to check whether there is a truck or not, the loading staff can effectively open the door and start the loading process. For example, D12 indicates that 11 minutes have elapsed since the loading started. At the comfort of his truck cab, the driver can visualize the status in real-time on his mobile device interface. The status may be updated in real-time. For example, a status update on D12 could pop up on the driver's mobile device stating there is a product shortage and an estimated delay, that loading will be completed in a few minutes, or other scenarios.

A vehicle or truck pre-inspection process is an inspection process ensuring the truck temperature and set-point are within the desired range as well as other potential safety checks, such as the cleanliness of the truck. These processes are typically carried out via manual paper-based inspections. In non-limiting embodiments, these processes may be incorporated as part of a mobile application for inspection and driver confirmation, signatures, and documentation.

In non-limiting embodiments, the door detection sensor may be used as an indicator of a state of a loading operation. For example, the door being detected as open could be an indicator of an initial start of a loading process and the door being detected as closed could be an indicator of an end of loading. Other combinations are possible such as partial loading, select items pending arrival of a transfer, items from another distribution center (DC), or the like. In this example, rather than leave the truck door open, the dock door could be closed but the truck would remain at the dock. The dock would still be marked as unavailable due to the combined logic of the door and vehicle/truck detection that would be sensing that the vehicle is still present at the dock, even though the door is closed. The status would only change when the vehicle departs and the door remains closed. Door status detection can be implemented using various methods such as proximity sensors, limit switches, and/or other contact or non-contact sensing technologies, depending on the configuration and operation of the door. In existing operations, upon completion and signaling of the loading operation, an operator may indicate via manually triggered LED indicators that they can now depart. The driver first checks out at the dispatch/shipping office where they sign some documents before departing the yard. This system described herein streamlines this process by enabling automatic indication of the loading completion via a mobile application and/or GUI on a mobile application as well as completing a check-out process directed via the application and the WMS/ERP system.

FIGS. 4A and 4B show mobile device GUIs 400, 410 according to non-limiting embodiments. A driver of a truck, for example, may use the GUIs 400, 410 to schedule an appointment with a loading dock, including obtaining a particular time and dock number. The GUIs 400, 410 may also be used to check-in once a driver arrives at a dock, check-out upon departure of the dock, upload documents (e.g., manifests, receipts, etc.), and other options. A driver may be shown, through the GUIs 400, 410, which dock loading door they are scheduled for, an order number, a workflow, and/or other comments. In the example shown GUI 400 of FIG. 4A, the numeral 12 indicates that loading is in process and 12 minutes have elapsed since the start of loading. The GUIs 400, 410 may display timers and icons as discussed above with respect to the GUIs 200, 210, 220 in FIGS. 2A-2C.

FIG. 5 shows a dashboard GUI 500 for displaying reports and analytics according to non-limiting embodiments. The analytics shown on dashboard GUI 500 include a summary of data from a period of time (e.g., a day, a week, a month, a year, etc.), including a total number of docks used, total number of loads, average loading time, average truck waiting time, and total downtime. Various other GUIs may be displayed to show reports and analytics, including tables, charts, and/or the like, able to be arranged by time period, dock, trucking company, manager, and/or the like.

FIG. 6 shows a chart GUI 600 for displaying a summary of data from a period of time (e.g., a day, a week, a month, a year, etc.) according to non-limiting embodiments. The chart GUI 600 may display an average loading time and an average truck waiting time for each individual dock (D001-D012). It will be appreciated that a chart may also be generated to show these statics for each loading cycle of a number of loading cycles (identified by time and/or date for example), rather than for each dock.

Other GUIs usable with non-limiting embodiments are shown in U.S. Design application No. 29/773,904, filed Mar. 12, 2021, the disclosure of which is hereby incorporated by reference in its entirety.

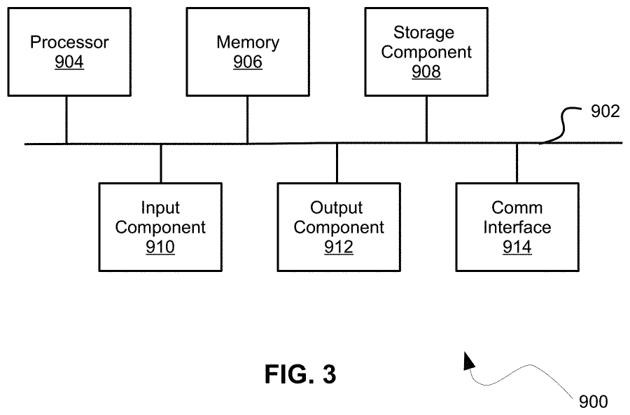

Referring now to FIG. 3, shown is a diagram of example components of a computing device 900 for implementing and performing the systems and methods described herein according to non-limiting embodiments. In some non-limiting embodiments, device 900 may include additional components, fewer components, different components, or differently arranged components than those shown in FIG. 3. Device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), virtual or augmented reality depicting systems and devices, etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 3, storage component 908 may store information and/or software related to the operation and use of device 900. For example, storage component 908 may include a hard disk (e.g., a magnetic disk, an optical disk, a magneto-optic disk, a solid-state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

The invention claimed is:

1. A system comprising:
a plurality of vehicle identification sensors arranged with respect to a plurality of loading docks, wherein each loading dock is associated with at least one vehicle sensor;
a plurality of door sensors arranged with respect to a plurality of doors associated with the plurality of loading docks, wherein each loading dock is associated with at least one door and at least one door sensor; and
at least one processor in communication with the plurality of vehicle sensors and the plurality of door sensors, the at least one processor configured to:
receive a plurality of signals from at least a subset of vehicle sensors of the plurality of vehicle sensors and at least a subset of door sensors from the plurality of door sensors;
start and/or stop at least one timer based on the plurality of signals; and
generate a graphical interface based on the at least one timer.

2. The system of claim 1, wherein the graphical user interface comprises a plurality of sections, each section of the plurality of sections associated with a different loading dock of the plurality of loading docks.

3. The system of claim 2, wherein at least one section of the plurality of sections comprises a timer display visually representing the at least one timer.

4. The system of claim 3, wherein the at least one processor is further configured to:
determine when the at least one timer satisfies a first threshold; and
in response to determining that the at least one timer satisfies the first threshold, modify the timer display by changing a color or other identifiable feature of the timer display.

5. The system of claim 3, wherein the at least one timer represents at least one of the following: a time from which a vehicle is detected by a vehicle sensor at a corresponding loading dock, a time from which a door at a corresponding loading dock is opened, and/or a time from which a door at a corresponding loading dock is closed and a vehicle is still detected by a vehicle sensor at the corresponding loading dock.

6. The system of claim 1, further comprising a sensor gateway in communication with the plurality of vehicle sensors and/or the plurality of door sensors, the sensor gateway configured to communicate sensor data to the at least one processor.

7. The system of claim 6, wherein the plurality of vehicle sensors and/or the plurality of door sensors are connected to the sensor gateway wirelessly.

8. The system of claim 1, wherein each vehicle sensor of the plurality of vehicle sensors comprises a sensor arranged at a height above a ground surface such that the vehicle sensor detects a top portion of a truck below the vehicle sensor.

9. A computer program product comprising at least one non-transitory computer readable medium including program instructions that, when executed by at least one processor, cause the at least one processor to:
receive a plurality of signals from at least a subset of vehicle sensors of a plurality of vehicle sensors and at least a subset of door sensors from a plurality of door sensors, wherein the plurality of vehicle sensors is arranged with respect to a plurality of loading docks, and wherein the plurality of door sensors is arranged with respect to a plurality of doors associated with the plurality of loading docks, each loading dock associated with at least one door, at least one vehicle sensor, and at least one door sensor;
start and/or stop at least one timer based on the plurality of signals; and
generate a graphical interface based on the at least one timer.

10. The computer program product of claim 9, wherein the graphical interface comprises a plurality of sections, each section of the plurality of sections associated with a different loading dock of the plurality of loading docks.

11. The computer program product of claim 10, wherein at least one section of the plurality of sections comprises a timer display visually representing the at least one timer.

12. The computer program product of claim 11, wherein the at least one processor is further caused to:
determine when the at least one timer satisfies a first threshold; and
in response to determining that the at least one timer satisfies the first threshold, modify the timer display by changing a color of the timer display.

13. The computer program product of claim 11, wherein the at least one timer represents at least one of the following: a time from which a vehicle is detected by a vehicle sensor at a corresponding loading dock, a time from which a door at a corresponding loading dock is opened, and/or a time from which a door at a corresponding loading dock is closed and a vehicle is still detected by a vehicle sensor at the corresponding loading dock.

14. The computer program product of claim 9, wherein the at least one processor receives the plurality of signals from a sensor gateway in communication with the plurality of vehicle sensors and/or the plurality of door sensors.

15. A method comprising:
arranging a plurality of vehicle sensors with respect to a plurality of loading docks, wherein each loading dock is associated with at least one vehicle sensor;
arranging a plurality of door sensors with respect to a plurality of doors associated with the plurality of loading docks, wherein each loading dock is associated with at least one door and at least one door sensor;
receiving a plurality of signals from at least a subset of vehicle sensors of the plurality of vehicle sensors and at least a subset of door sensors from the plurality of door sensors;
starting and/or stopping at least one timer based on the plurality of signals; and
generating a graphical interface based on the at least one timer.

16. The method of claim 15, wherein the graphical user interface comprises a plurality of sections, each section of the plurality of sections associated with a different loading dock of the plurality of loading docks.

17. The method of claim 16, wherein at least one section of the plurality of sections comprises a timer display visually representing the at least one timer.

18. The system of claim 1, further comprising a mobile application executing on a mobile device operated by a driver, the mobile application including program instructions that, when executed by the mobile device, cause the mobile device to:
receive, from the at least one processor, data generated from the plurality of signals; and
in response to receiving the data, display a graphical user interface configured to enable the driver to check-in or check-out.

19. The system of claim 18, wherein the program instructions further cause the mobile device to:
automatically detect that the mobile device is in a geographic area; and
in response to detecting that the mobile device is in a geographic area, communicating a notification to the at least one processor.

20. The system of claim 19, wherein the program instructions further cause the mobile device to display a mobile graphical interface based on the graphical interface.
